(19) United States
(12) Patent Application Publication
(10) Pub. No.: US 2003/0150460 A1
(43) Pub. Date: Aug. 14, 2003

(54) Oxygen mask retention device and method for retaining an oxygen mask

(76) Inventors: George L. Campbell SR., Phoenix, AZ (US); Lucky Campbell, Phoenix, AZ (US)

Correspondence Address: WEISS & MOY PC, 4204 NORTH BROWN AVENUE, SCOTTSDALE, AZ, 85251, US

(21) Appl. No.: 10/378,140

(22) Filed: Mar. 4, 2003

Related U.S. Application Data
(63) Continuation-in-part of application No. 10/166,753, filed on Jun. 12, 2002.
(60) Provisional application No. 60/354,484, filed on Feb. 8, 2002.

(51) Int. Cl. A62B 7/10; A62B 18/08

(52) U.S. Cl. 128/206.13; 128/206.27; 128/207.11

(57) ABSTRACT

A retention device and method for retaining an object, including preferably a gas mask, in position proximate a user's mouth. The retention device includes straps coupled to both sides of the object and having at ends thereof ear pieces. The ear pieces fit over the ears, and are configured to receive the strap at a point proximate the tragus portion of the ear, causing pulling forces to be on the posterior center portion of the ear rather than on the top of the ear. The ear pieces have a downwardly exterior anterior leg and a downwardly extending posterior leg. In one embodiment, the ear pieces are substantially U-shaped. In another embodiment, the ear pieces are substantially ring-shaped.

### RELATED APPLICATION

This is a continuation-in-part of U.S. patent application Ser. No. 10/166,753, filed Jun. 12, 2002, in the name of the Applicant, which claimed priority from Provisional Application No. 60/354,484, filed on Feb. 8, 2002.

### BACKGROUND OF THE INVENTION

1. Field of the Invention

The present invention relates generally to medical devices, and more specifically, to a device and method for retaining a gas delivery system on the head of a recipient of a gas, particularly in trauma situations.

2. Background of the Invention

It is often necessary to supply oxygen or a gas mixture to a hospitalized patient or to an individual requiring supplemental assistance with breathing or who is subjected to a low-oxygen environment. This occurs, frequently, in trauma situations.

Often, in a trauma situation, an oxygen mask having a gas supply received through a bottom portion thereof will be utilized to deliver gas to the patient. In such instance, the mask is typically fitted with an elastic strap, which is intended to be fitted above the ears and around the back of the head of the individual who is to receive the gas. However, this requires the lifting of the head of the individual, which in a trauma situation can be difficult or undesired.

In a trauma situation, where the mask is to be positioned without lifting the head of the patient and without the patient's assistance, it is further desired to provide an ear piece associated with the mask that is configured to more readily facilitate its secure placement over the ear by a care provider.

Therefore, it is desirable to provide a device and method that will permit effective retention of a mask in a trauma situation without the necessity of lifting the head of the patient to position the mask. Additionally, it is desirable to provide a device and method wherein the ear piece portion of the mask is adapted to facilitate easier placement by a care provider over a patient's ears.

The present invention satisfies these needs and provides other, related, advantages.

### SUMMARY OF THE INVENTION

It is an object of the present invention to provide a device and method that will permit effective positioning and retention of a mask in a trauma situation.

It is a further object of the present invention to provide a device and method that will permit effective positioning and retention of a mask in a trauma situation, and that does not require the lifting of the head of the patient to position the mask.

It is a still further object of the present invention to provide a retention device and method that will permit effective positioning and retention of a mask in a trauma situation, and that will locate the pulling force on the mask proximate the center portion of the ear.

### BRIEF DESCRIPTION OF THE PREFERRED EMBODIMENTS

In accordance with one embodiment of the present invention, a gas retention device is disclosed. The device comprises, in combination: an object to be positioned proximate a mouth of a user; a first strap coupled to a first side of the object and extending toward one of the user's ears; a second strap coupled to a second side of the object and extending toward another of the user's ears; a first ear piece coupled to the first strap at a first coupling point and wherein the first coupling point serves as an entry point for the first strap; wherein the first ear piece has a downwardly extending leg positionable on an anterior side of the user's ear and a downwardly extending leg on a posterior side of the user's ear; and a second ear piece coupled to the second strap at a second coupling point and wherein the second coupling point serves as an entry point for the second strap; wherein the second ear piece has a downwardly extending leg positionable on an anterior side of the user's ear and a downwardly extending leg on a posterior side of the user's ear; wherein, in use, each of the first coupling point and the second coupling point is located at a point proximate a corresponding tragus region of one of the user's ears; and wherein each of the first ear piece and the second ear piece is sufficiently rigid to transfer tension exerted by the object to a posterior region of the user's ears.

an object to be positioned proximate a mouth of a user; a first strap coupled to a first side of the object and extending toward one of the user's ears; a second strap coupled to a second side of the object and extending toward another of the user's ears; a first ear piece coupled to the first strap; and a second ear piece coupled to the second strap; wherein each of the first ear piece and the second ear piece is coupled to a corresponding strap at a point proximate a corresponding anterior, central portion of the user's ear; wherein each of the first ear piece and the second ear piece is sufficiently rigid to transfer tension exerted by the object to a back of the user's ears.

In accordance with another embodiment of the present invention, a method for retaining an object proximate a user's mouth is disclosed. The method comprises the steps of: providing an object to be positioned proximate a mouth of a user who is lying in a supine position on a surface; wherein the object is an oxygen mask; providing a first strap coupled to a first side of the object and extending toward one of the user's ears; providing a second strap coupled to a second side of the object and extending toward another of the user's ears; providing a first ear piece coupled to the first strap at a first coupling point and wherein the first coupling point serves as an entry point for the first strap; wherein the first ear piece has a downwardly extending leg positionable on an anterior side of the user's ear and a downwardly extending leg on a posterior side of the user's ear; providing a second ear piece coupled to the second strap at a second coupling point and wherein the second coupling point serves as an entry point for the second strap; wherein the second ear piece has a downwardly extending leg positionable on an anterior side of the user's ear and a downwardly extending leg on a posterior side of the user's ear; wherein, in use, each of the first coupling point and the second coupling point is located at a point proximate a corresponding tragus region of one of the user's ears; wherein each of the first ear piece and the second ear piece is sufficiently rigid to transfer tension exerted by the object to a poster region of the user's ears; positioning the object proximate the mouth of the user; positioning the first ear piece over the one the ear of the user without lifting the head of the user and while maintaining contact between the head and the surface; and positioning the second ear piece over the other the ear of the user without lifting the head of the user and while maintaining contact between the head and the surface.

### BRIEF DESCRIPTION OF THE DRAWINGS

FIG. 1 is a side view showing an embodiment of an oxygen mask retention system consistent with the present invention.

FIG. 2 is a side view showing the ear piece portion of an embodiment of an oxygen mask retention system consistent with the present invention, prior to placement on a recipient's ear.

FIG. 3 is a side view showing the ear piece portion of another embodiment of an oxygen mask retention system consistent with the present invention, in place on a recipient's ear.

FIG. 4 is a side view showing the ear piece portion of an embodiment of an oxygen mask retention system consistent with the present invention, prior to placement on a recipient's ear.

FIG. 5 is a perspective view, illustrating the positioning of an embodiment of an oxygen mask retention system consistent with the present invention on a trauma patient who is laying in a supine position on a surface.

FIG. 6 is a perspective view, illustrating an embodiment of an oxygen mask retention system consistent with the present invention in position on a trauma patient who is laying in a supine position on a surface.

### DETAILED DESCRIPTION OF THE PREFERRED EMBODIMENTS

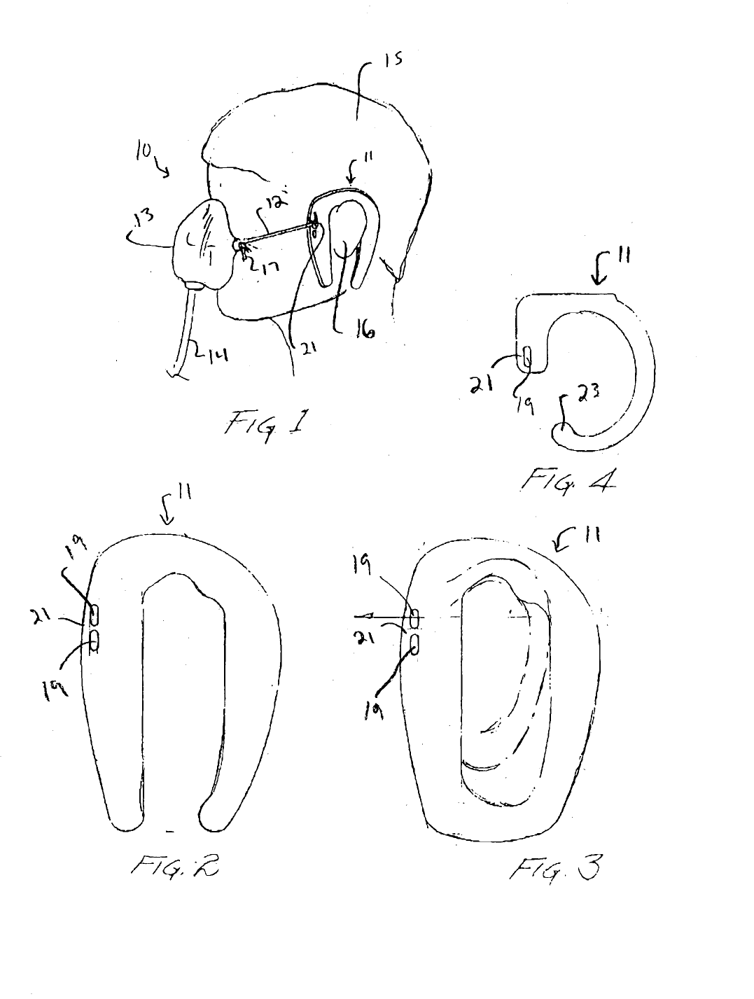

Referring first to FIG. 1, an embodiment of an oxygen mask retention system 10 according to the present invention is shown. The oxygen mask retention system 10 generally comprises an oxygen mask retention device 11, two elastic straps 12 (the one on the other side of a recipient's head 15 is not shown), an oxygen mask 13, and a gas supply tube 14. The oxygen mask 13 receives its gas supply through a bottom portion thereof, through the gas supply tube 14.

Preferably, each elastic strap 12 is secured at a first end to a side of the oxygen mask 13, preferably in an adjustable manner. Such adjustment may be provided by passing the elastic strap 12 in the direction of the oxygen mask 13 through a first slot on a side of the oxygen mask 13, and then pulling the elastic strap 12 in the direction of the oxygen mask retention device 11 through a second slot on the side of the oxygen mask 13. This will leave a free end 17 of elastic strap 12 exposed. To tighten the oxygen mask 13, the user will pull on the free end 17 after the oxygen mask retention device 11 and oxygen mask 13 are in place. To loosen the oxygen mask 13, the user will pull on the elastic strap 12 in the direction of the oxygen mask retention device 11.

The oxygen mask retention device 11 is secured to a second end of each elastic strap 12, and positioned on each of the recipient's ears 16 to secure the oxygen mask 13 in position on the recipient's head 15. As shown in FIGS. 1-4, openings 19 may be provided on the oxygen mask retention device 11 to provide an adjustable coupling of the elastic strap 12 to the oxygen mask retention device 11, either in place of or in addition to the adjustable coupling provided at the sides of the oxygen mask 13.

When in position, the oxygen mask 13 will supply oxygen to the recipient. Depending on the configuration of the oxygen mask 13, delivery of oxygen can be to the mouth and/or the nose of the recipient. As used herein, the phrase “proximate a mouth” shall include the positioning of a mask over the mouth, over the nose, inserted within nostrils, or any combination thereof. In addition, the term “mask” as used herein shall include nipples coupled to a cannula and inserted within nostrils as well as any mask-type structure positionable over at least one of a nose and a mouth.

Now referring to FIGS. 1-4, the oxygen mask retention device 11 is coupled at a point 21 to the elastic strap 12 at one end, through openings 19. The retention device 11 is curved, to conform to the curvature of the recipient's ear 16. Although not required, it is preferred to provide a bulbed area 23 at the open end of the retention device 11 to reduce the sharpness and to thereby improve the comfort of the recipient (see FIG. 4).

As shown in detail in FIGS. 1, 3, and 6, the configuration of the oxygen mask retention device 11 positions the elastic strap 12 proximate the tragus region of the recipient's ear 16, as opposed to the top as in a typical eye glass ear piece. As a result, the forward pulling force when the retention device 11 is in position is transferred directly behind the recipient's ear 16, resulting in a more secure fit of the oxygen mask 13 to the recipient's head and a lower risk of dislodging the oxygen mask 13 accidentally.

The oxygen mask retention device 11 will preferably be molded out of the plastic material, such as a thermoplastic elastomer material, though other materials may be utilized. For example, a cardboard type of material has been found to be suitable for such use. The material used should be hypoallergenic and sufficiently rigid to permit the oxygen mask retention device 11 to transfer tension to the back of the recipient's ear 16, while permitting comfortable use with some flexure as will occur with movement of the recipient's head 15 and compression if the weight of recipient's head 15 rests on one of the recipient's ears 16.

The oxygen mask retention device 11 can be modified in size and shape to comfortably fit on different ear sizes, to accommodate adults, children, and infants.

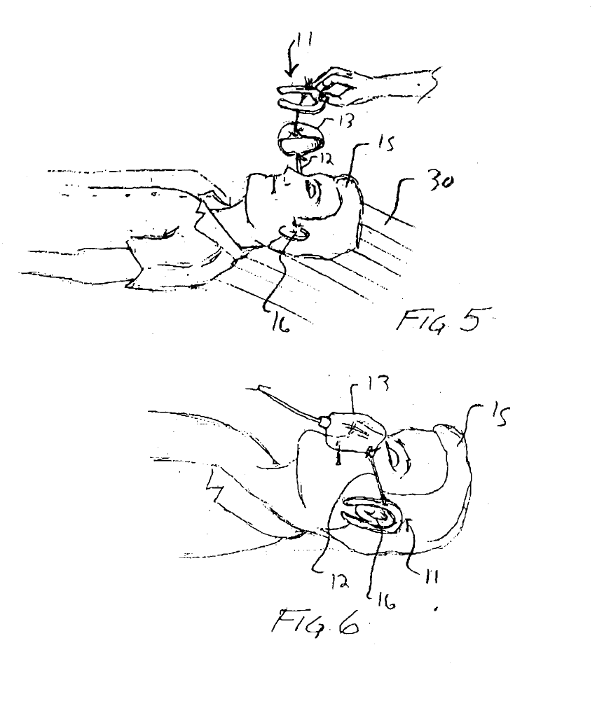

The oxygen mask retention device 11 may be used in a particularly effective manner with trauma patients, where an injured patient is lying in a supine position on a surface 30, as shown in FIGS. 5 and 6. As shown in these Figures, the design of the oxygen mask retention device 11 allows the recipient's head 15 to be left lying down on the surface 30, with the oxygen mask 13 secured by positioning the retention device 11 over each of the recipient's ears 16. The types of trauma situations in which the oxygen mask retention device 11 might be used include the use by the military for battlefield casualties.

Referring now to FIG. 2, an embodiment of the oxygen mask retention device 11 is shown, in which the device 11 has a substantially U-shape. (By a substantially U-shape, the intention is to describe a configuration for the retention device 11 wherein the device 11 has a downwardly extending leg on the anterior side of the ear 16 and a downwardly extending leg on the posterior side of the ear 16, and wherein the inferior terminus portion on the anterior leg is approximately at the same height as the inferior terminus portion on the posterior leg. Preferably, as shown in this figure, the retention device 11 has a relatively wide surface area that is, as shown in FIG. 5, preferably at least as wide as the majority of the distal phalange portion of the fingers. This configuration further facilitates the task of grasping the device 11 and manipulating it into position on a user's ear 16, by providing increased surface area for grasping by a care provider. Moreover, because the device 11 in this embodiment has a substantially U-shape and is open at the bottom, it may be slid downward over the ear 16 of the patient and into position.

Referring now to FIG. 3, an embodiment of the oxygen mask retention device 11 is shown, in which the device 11 has a substantially ring shape. In this regard, the anterior and posterior legs of the device 11 extend downward as in the embodiment shown in FIG. 2, with the exception that instead of the structure being open between below the ear 16, the legs of the device 11 at joined at the inferior portions thereof so as to make the device 11 continuous. Preferably, as shown in this figure, the retention device 11 has a relatively wide surface area that is, as shown in FIG. 6, preferably at least as wide as the majority of the distal phalange portion of the fingers. This configuration further facilitates the task of grasping the device 11 and manipulating it into position on a user's ear 16, by providing increased surface area for grasping by a care provider, including a portion at the base of the ear.

While the depictions of FIGS. 1-6 are described as applying to an oxygen mask, it should be understood that the retention device of the present invention is suitable for use with other gases and with other delivery systems, as well as filters and other breathing apparatus. The invention may also be applied to securing other devices to a patient's head, such as securing dental bridgework during and after installation. In such embodiments, it may be necessary, for example, to form the elastic straps 12 from a rigid, non-elastic material to provide stronger support. The elastic straps 12 could be, for example, a cannula. The term “strap” as used herein is intended to include both elastic and non-elastic versions.

While the invention has been particularly shown and described with reference to the preferred embodiments thereof, it will be understood by those skilled in the art that the foregoing and other changes in form, and details may be made therein without departing from the spirit and scope of the invention.

I claim:

1. A retention device comprising, in combination:
an object to be positioned proximate a mouth of a user;
a first strap coupled to a first side of said object and extending toward one of said user's ears;
a second strap coupled to a second side of said object and extending toward another of said user's ears;
a first ear piece coupled to said first strap at a first coupling point and wherein said first coupling point serves as an entry point for said first strap;
wherein said first ear piece has a downwardly extending leg positionable on an anterior side of said user's ear and a downwardly extending leg on a posterior side of said user's ear; and
a second ear piece coupled to said second strap at a second coupling point and wherein said second coupling point serves as an entry point for said second strap;
wherein said second ear piece has a downwardly extending leg positionable on an anterior side of said user's ear and a downwardly extending leg on a posterior side of said user's ear;
wherein, in use, each of said first coupling point and said second coupling point is located at a point proximate a corresponding tragus region of one of said user's ears; and
wherein each of said first ear piece and said second ear piece is sufficiently rigid to transfer tension exerted by said object to a posterior region of said user's ears.

2. The retention device of claim 1 wherein each of said first ear piece and said second ear piece define a substantially U-shape.

3. The retention device of claim 2 wherein, in use, an inferior terminus portion on said anterior leg is approximately at an equivalent height to an inferior terminus portion on said posterior leg.

4. The retention device of claim 1 wherein each of said first ear piece and said second ear piece define a substantially ring shape.

5. The retention device of claim 1 wherein said object is an oxygen mask.

6. A method for retaining an object proximate a user's mouth comprising the steps of:
providing an object to be positioned proximate a mouth of a user who is lying in a supine position on a surface;
wherein said object is an oxygen mask;
providing a first strap coupled to a first side of said object and extending toward one of said user's ears;
providing a second strap coupled to a second side of said object and extending toward another of said user's ears;
providing a first ear piece coupled to said first strap at a first coupling point and wherein said first coupling point serves as an entry point for said first strap;
wherein said first ear piece has a downwardly extending leg positionable on an anterior side of said user's ear and a downwardly extending leg on a posterior side of said user's ear;
providing a second ear piece coupled to said second strap at a second coupling point and wherein said second coupling point serves as an entry point for said second strap;
wherein said second ear piece has a downwardly extending leg positionable on an anterior side of said user's ear and a downwardly extending leg on a posterior side of said user's ear;
wherein, in use, each of said first coupling point and said second coupling point is located at a point proximate a corresponding tragus region of one of said user's ears;
wherein each of said first ear piece and said second ear piece is sufficiently rigid to transfer tension exerted by said object to a poster region of said user's ears;
positioning said object proximate said mouth of said user;
positioning said first ear piece over the one said ear of said user without lifting the head of said user and while maintaining contact between the head and said surface; and
positioning said second ear piece over the other said ear of said user without lifting the head of said user and while maintaining contact between the head and said surface.

7. The method of claim 6 wherein each of said first ear piece and said second ear piece define a substantially U-shape.

8. The method of claim 7 wherein, in use, an inferior terminus portion on said anterior leg is approximately at an equivalent height to an inferior terminus portion on said posterior leg.

9. The method of claim 7 wherein each of said first ear piece and said second ear piece define a substantially ring shape.
